(19) United States
(12) Patent Application Publication
(10) Pub. No.: US 2009/0265615 A1
(43) Pub. Date: Oct. 22, 2009

(54) DATA PROCESSING SERVER AND DATA PROCESSING METHOD

(76) Inventors: Masahiko Hatori, Tokushima-shi (JP); Hideki Hiura, Tokushima-shi (JP); Hiroyuki Oota, Tokushima-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 12/300,248

(22) PCT Filed: May 15, 2007
(86) PCT No.: PCT/JP2007/000522

§ 371 Date: Jun. 22, 2009

(30) Foreign Application Priority Data
May 15, 2006 (JP) 2006-135861

(51) Int. Cl. G06F 17/00

(52) U.S. Cl. 715/239

(57) ABSTRACT

A screen in which multiple documents are integrated and displayed is provided. An XML data acquisition unit refers to a user database and acquires content data registered by a user from a web server. An HTML data conversion unit converts XML data into HTML data. A module builder builds a module for acknowledging a request for processing the XML data in order to allow the user to work on and edit the XML data. A transmission unit attaches the module built to the HTML data produced by conversion so as to create a web page. The unit transmits the web page created to a user terminal. A processing request acknowledgement unit acknowledges a request for processing the XML data from the user terminal via the module. A processing request conversion unit converts the received request for processing the XML data into an instruction that can be executed by a document processing apparatus.

### TECHNICAL FIELD

The present invention relates to a data processing technology and, more particularly, to a data processing server and a data processing method adapted to process data described in a markup language.

### BACKGROUND ART

XML gains attention as a format suitable to share data with others over a network. Applications for creating, displaying, and editing XML documents are developed (see, for example, patent document No. 1). An XML document is created based on a vocabulary (tag set) defined by, for example, a document type definition.

In association with the explosive growth of Internet, an enormous amount of web pages are provided. Currently, a majority of web pages are described in the Hypertext Markup Language (HTML). Users can view web pages using a web browser capable of displaying HTML files.

[patent document No. 1] JP 2001-290804

### DISCLOSURE OF THE INVENTION

### Problem to be Solved by the Invention

In a related-art web application using a web browser, the entirety page had to be reloaded in order to communicate data to a server and obtain a result of processing. Recently, Ajax technologies have gained attention for their capability to achieve an interactive web application capable of exchanging data with a server and performing processes accordingly without reloading web pages. For this purpose, Ajax uses the HTTP communication capability of Java (registered trademark) Script implemented in a web browser. Ajax achieves a seamless web application that makes a server virtually transparent, by communicating with a server asynchronously in parallel with user manipulations and screen refreshing.

We have furthered Ajax technologies and arrived at a technology capable of providing more convenient services. In this background, a general purpose of the present invention is to provide a technology capable of properly processing XML data provided via a network.

### Means to Solve the Problem

An aspect of the present invention relates to a data processing server. The data processing server comprises: an XML data acquisition unit operative to acquire XML data; an HTML data conversion unit operative to convert XML data into HTML data; a transmission unit operative to attach, to the HTML data produced by conversion, a module for acknowledging a request for processing the XML data as a request for processing HTML data and to transmit the resultant data; and a processing unit operative to acknowledge a request, provided via the module, for processing the XML data and to process the XML data accordingly.

The data processing server may further comprise a processing request conversion unit operative to convert a request, provided via the module, for processing the XML data into an instruction that can be executed by the processing unit. Upon being requested to process the XML data via the module, the HTML data conversion unit converts the XML data processed by the processing unit into HTML data, and the transmission unit transmits the HTML data produced by conversion to the destination requesting the XML data to be processed. The HTML data conversion unit maintains, for each tag set of XML, a rule for converting XML data into HTML data, and converts the XML data acquired by the XML data acquisition unit into HTML data in accordance with the rule.

The data processing server may further comprise a module builder operative to build a module in accordance with the XML data.

The HTML data may be data describing a web page displayed in a web browser of a user terminal, the module may acknowledge a request for adding XML data to be displayed as content in the web page, the XML data acquisition unit may acquire the XML data requested to be added, the HTML data conversion unit may convert the XML data additionally acquired into HTML data, the module builder may build a module for acknowledging a request for processing the XML data additionally acquired, and the transmission unit may attach the HTML data produced by conversion to the original HTML data, attach the module built to the resultant HTML data, and transmit the resultant data to the user terminal. The data processing server may further comprise a user database operative to store XML data to be displayed in the web page or an address of the XML data.

Upon receipt from the user terminal a request for locally editing the XML data, the transmission unit may transmit the processing unit to the user terminal.

The processing unit may further comprise: a tag set processing unit operative to process data described in a specific tag set of XML; and a mapping unit operative to map the XML data into a tag set that can be processed by the tag set processing unit and maintain correspondence between the elements mapped. The data processing server may further comprise a definition data creating unit operative to generate definition data describing a rule for mapping the XML data included in a web page to be transmitted to the user terminal into a tag set that can be processed by the tag set processing unit, wherein the transmission unit may transmit the definition data to the user terminal along with the processing unit.

Another aspect of the present invention relates to a data processing method. The data processing method comprises: acquiring XML data; converting XML data into HTML data; attaching, to the HTML data produced by conversion, a module for acknowledging a request for processing the XML data as a request for processing HTML data, and transmitting the resultant data; and acknowledging a request, provided via the module, for processing the XML data and processing the XML data accordingly.

Optional combinations of the aforementioned constituting elements, and implementations of the invention in the form of methods, apparatuses, and systems may also be practiced as additional modes of the present invention.

### ADVANTAGE OF THE PRESENT INVENTION

The present invention provides a technology adapted to properly processing XML data provided via a network.

### BRIEF DESCRIPTION OF THE DRAWINGS

FIG. 1 is a diagram which shows a configuration of a document processing apparatus according to the base technology;

FIG. 2 is a diagram which shows an example of an XML document which is a processing target;

FIG. 3 is a diagram which shows an example in which the XML document shown in FIG. 2 is mapped to a table described in HTML;

FIG. 4A is a diagram which shows an example of a definition file used for mapping the XML document shown in FIG. 2 to the table shown in FIG. 3;

FIG. 4B is a diagram which shows an example of a definition file used for mapping the XML document shown in FIG. 2 to the table shown in FIG. 3;

FIG. 5 is a diagram which shows an example of a screen on which the XML document, which is shown in FIG. 2, is displayed after having been mapped to HTML according to the correspondence shown in FIG. 3;

FIG. 6 is a diagram which shows an example of a graphical user interface provided by a definition file creating unit, which allows the user to create a definition file;

FIG. 7 is a diagram which shows another example of a screen layout created by the definition file creating unit;

FIG. 8 is a diagram which shows an example of an editing screen for an XML document, as provided by the document processing apparatus;

FIG. 9 is a diagram which shows another example of an XML document which is to be edited by the document processing apparatus;

FIG. 10 is a diagram which shows an example of a screen on which the document shown in FIG. 9 is displayed;

FIG. 11 shows the structure of a data processing server according to the embodiment;

FIG. 12 shows an exemplary screen displayed in a browser of a user terminal;

FIG. 13 shows an exemplary screen showing a web page containing a plurality of contents;

FIG. 14 shows an exemplary screen in which a web page is edited; and

FIG. 15 shows an exemplary screen in which a portion of a web page is updated.

### DESCRIPTION OF THE REFERENCE NUMERALS

20 document processing apparatus, 22 main control unit, 24 editing unit, 25 web server, 26 user terminal, 30 DOM unit, 32 DOM provider, 34 DOM builder, 36 DOM writer, 40 CSS unit, 42 CSS parser, 44 CSS provider, 46 rendering unit, 50 HTML unit, 52, 62 control unit, 54, 64 editing unit, 56, 66 display unit, 60 SVG unit, 71 user authentication unit, 72 XML data acquisition unit, 73 user database, 74 transmission unit, 75 module builder, 76 HTML data conversion unit, 77 processing request acknowledgement unit, 78 processing request conversion unit, 79 definition data creating unit, 80 VC unit, 82 mapping unit, 84 definition file acquisition unit, 86 definition file creating unit, 100 data processing server

### BEST MODE FOR CARRYING OUT THE INVENTION

A description will first be given of a base technology directed to processing XML documents described in an arbitrary tag set. A description will then be given of an embodiment of the present invention. More specifically, a description will be given of a technology whereby the document processing apparatus of the base technology is used as an application server in the middle layer so that a web page in which a plurality of web services are integrated is provided.

(Base Technology)

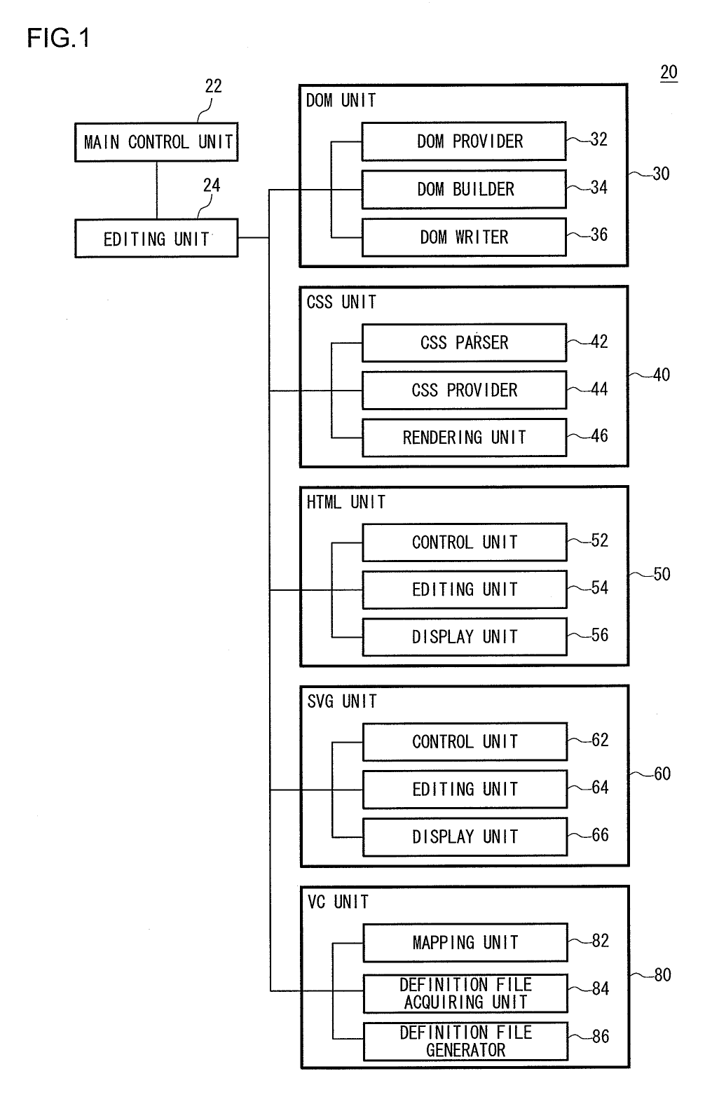

FIG. 1 illustrates a structure of a document processing apparatus 20 according to Base Technology. The document processing apparatus 20 processes a structured document where data in the document are classified into a plurality of components having a hierarchical structure. Represented in Base Technology is an example in which an XML document, as one type of a structured document, is processed. The document processing apparatus 20 is comprised of a main control unit 22, an editing unit 24, a DOM unit 30, a CSS unit 40, an HTML unit 50, an SVG unit 60 and a VC unit 80 which serves as an example of a conversion unit. In terms of hardware components, these unit structures may be realized by any conventional processing system or equipment, including a CPU or memory of any computer, a memory-loaded program, or the like. Here, the drawing shows a functional block configuration which is realized by cooperation between the hardware components and software components. Thus, it should be understood by a person skilled in the art that these functional blocks can be realized in a variety of forms by hardware only, software only or the combination thereof.

The main control unit 22 provides for the loading of a plug-in or a framework for executing a command. The editing unit 24 provides a framework for editing XML documents. Display and editing functions for a document in the document processing apparatus 20 are realized by plug-ins, and the necessary plug-ins are loaded by the main control unit 22 or the editing unit 24 according to the type of document under consideration. The main control unit 22 or the editing unit 24 determines which vocabulary or vocabularies describes the content of an XML document to be processed, by referring to a name space of the document to be processed, and loads a plug-in for display or editing corresponding to the thus determined vocabulary so as to execute the display or the editing. For instance, an HTML unit 50, which displays and edits HTML documents, and an SVG unit 60, which displays and edits SVG documents, are implemented in the document processing apparatus 20. That is, a display system and an editing system are implemented as plug-ins for each vocabulary (tag set), so that when an HTML document and an SVG document are edited, HTML unit 50 and the SVG unit 60 are loaded, respectively. As will be described later, when compound documents, which contain both HTML and SVG components, are to be processed, both HTML unit 50 and the SVG unit 60 are loaded.

By implementing the above structure, a user can select so as to install only necessary functions, and can add or delete a function or functions at a later stage, as appropriately. Thus, the storage area of a recording medium, such as a hard disk, can be effectively utilized, and the wasteful use of memory can be prevented at the time of executing programs. Furthermore, since the capability of this structure is highly expandable, a developer can deal with new vocabularies in the form of plug-ins, and thus the development process can be readily facilitated. As a result, the user can also add a function or functions easily at low cost by adding a plug-in or plug-ins.

The editing unit 24 receives an event, which is an editing instruction, from the user via the user interface. Upon reception of such an event, the editing unit 24 notifies a suitable plug-in or the like of this event, and controls the processing such as redoing this event, canceling (undoing) this event, etc.

The DOM unit 30 includes a DOM provider 32, a DOM builder 34 and a DOM writer 36. The DOM unit 30 realizes functions in compliance with a document object model (DOM), which is defined to provide an access method used for handling data in the form of an XML document. The DOM provider 32 is an implementation of a DOM that satisfies an interface defined by the editing unit 24. The DOM builder 34 creates DOM trees from XML documents. As will be described later, when an XML document to be processed is mapped to another vocabulary by the VC unit 80, a source tree, which corresponds to the XML document in a mapping source, and a destination tree, which corresponds to the XML document in a mapping destination, are created. At the end of editing, for example, the DOM writer 36 outputs a DOM tree as an XML document.

The CSS unit 40, which provides a display function conforming to CSS, includes a CSS parser 42, a CSS provider 44 and a rendering unit 46. The CSS parser 42 has a parsing function for analyzing the CSS syntax. The CSS provider 44 is an implementation of a CSS object and performs CSS cascade processing on the DOM tree. The rendering unit 46 is a CSS rendering engine and is used to display documents, described in a vocabulary such as HTML, which are laid out using CSS.

HTML unit 50 displays or edits documents described in HTML. The SVG unit 60 displays or edits documents described in SVG. These display/editing systems are realized in the form of plug-ins, and each system is comprised of a display unit (also designated herein as a “canvas”) 56 and 66, which displays documents, a control unit (also designated herein as an “editlet”) 52 and 62, which transmits and receives events containing editing commands, and an edit unit (also designated herein as a “zone”) 54 and 64, which edits the DOM according to the editing commands. Upon the control unit 52 or 62 receiving a DOM tree editing command from an external source, the edit unit 54 or 64 modifies the DOM tree and the display unit 56 or 66 updates the display. These units have a structure similar to the framework of the so-called MVC (Model-View-Controller). With such a structure, in general, the display units 56 and 66 correspond to “View”. On the other hand, the control units 52 and 62 correspond to “Controller”, and the edit units 54 and 64 and DOM instance corresponds to “Model”. The document processing apparatus 20 according to the Base Technology allows an XML document to be edited according to each given vocabulary, as well as providing a function of editing HTML document in the form of tree display. HTML unit 50 provides a user interface for editing an HTML document in a manner similar to a word processor, for example. On the other hand, the SVG unit 60 provides a user interface for editing an SVG document in a manner similar to an image drawing tool.

The VC unit 80 includes a mapping unit 82, a definition file acquiring unit 84 and a definition file generator 86. The VC unit 80 performs mapping of a document, which has been described in a particular vocabulary, to another given vocabulary, thereby providing a framework that allows a document to be displayed and edited by a display/editing plug-in corresponding to the vocabulary to which the document is mapped. In the Base Technology, this function is called a vocabulary connection (VC). In the VC unit 80, the definition file acquiring unit 84 acquires a script file in which the mapping definition is described. Here, the definition file specifies the correspondence (connection) between the Nodes for each Node. Furthermore, the definition file may specify whether or not editing of the element values or attribute values is permitted. Furthermore, the definition file may include operation expressions using the element values or attribute values for the Node. Detailed description will be made later regarding these functions. The mapping unit 82 instructs the DOM builder 34 to create a destination tree with reference to the script file acquired by the definition file acquiring unit 84. This manages the correspondence between the source tree and the destination tree. The definition file generator 86 offers a graphical user interface which allows the user to create a definition file.

The VC unit 80 monitors the connection between the source tree and the destination tree. Upon reception of an editing instruction from the user via a user interface provided by a plug-in that handles a display function, the VC unit 80 first modifies a relevant Node of the source tree. As a result, the DOM unit 30 issues a mutation event indicating that the source tree has been modified. Upon reception of the mutation event thus issued, the VC unit 80 modifies a Node of the destination tree corresponding to the modified Node, thereby updating the destination tree in a manner that synchronizes with the modification of the source tree. Upon reception of a mutation event that indicates that the destination tree has been modified, a plug-in having functions of displaying/editing the destination tree, e.g., HTML unit 50, updates a display with reference to the destination tree thus modified. Such a structure allows a document described in any vocabulary, even a minor vocabulary used in a minor user segment, to be converted into a document described in another major vocabulary. This enables such a document described in a minor vocabulary to be displayed, and provides an editing environment for such a document.

An operation in which the document processing apparatus 20 displays and/or edits documents will be described herein below. When the document processing apparatus 20 loads a document to be processed, the DOM builder 34 creates a DOM tree from the XML document. The main control unit 22 or the editing unit 24 determines which vocabulary describes the XML document by referring to a name space of the XML document to be processed. If the plug-in corresponding to the vocabulary is installed in the document processing apparatus 20, the plug-in is loaded so as to display/edit the document. If, on the other hand, the plug-in is not installed in the document processing apparatus 20, a check shall be made to see whether a mapping definition file exists or not. And if the definition file exits, the definition file acquiring unit 84 acquires the definition file and creates a destination tree according to the definition, so that the document is displayed/edited by the plug-in corresponding to the vocabulary which is to be used for mapping. If the document is a compound document containing a plurality of vocabularies, relevant portions of the document are displayed/edited by plug-ins corresponding to the respective vocabularies, as will be described later. If the definition file does not exist, a source or tree structure of a document is displayed and the editing is carried out on the display screen.

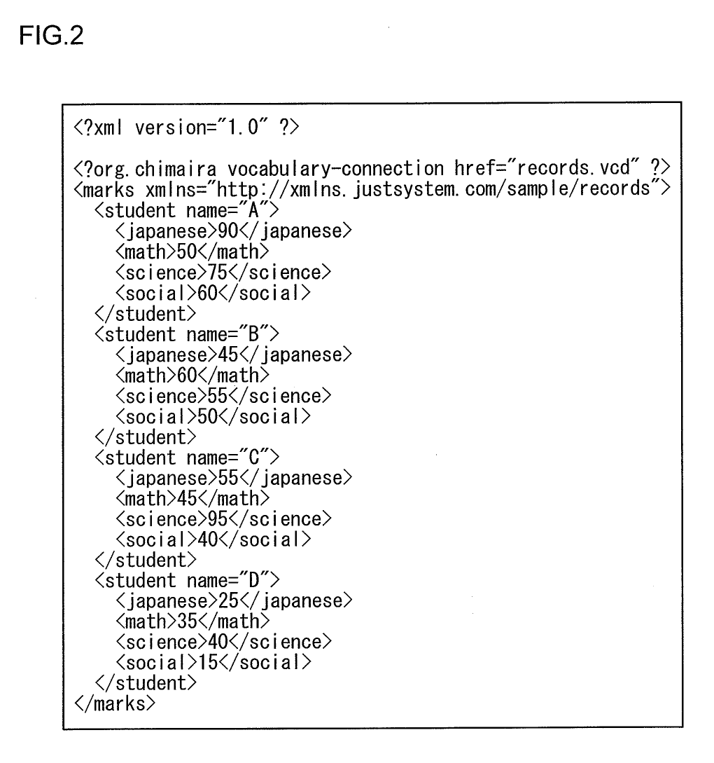

FIG. 2 shows an example of an XML document to be processed. According to this exemplary illustration, the XML document is used to manage data concerning grades or marks that students have earned. A component “marks”, which is the top Node of the XML document, includes a plurality of components “student” provided for each student under “marks”. The component “student” has an attribute “name” and contains, as child elements, the subjects “japanese”, “mathematics”, “science”, and “social_studies”. The attribute “name” stores the name of a student. The components “japanese”, “mathematics”, “science” and “social_studies” store the test scores for the subjects Japanese, mathematics, science, and social studies, respectively. For example, the marks of a student whose name is “A” are “90” for Japanese, “50” for mathematics, “75” for science and “60” for social studies. Hereinafter, the vocabulary (tag set) used in this document will be called “marks managing vocabulary”.

Here, the document processing apparatus 20 according to the Base Technology does not have a plug-in which conforms to or handles the display/editing of marks managing vocabularies. Accordingly, before displaying such a document in a manner other than the source display manner or the tree display manner, the above-described VC function is used. That is, there is a need to prepare a definition file for mapping the document, which has been described in the marks managing vocabulary, to another vocabulary, which is supported by a corresponding plug-in, e.g., HTML or SVG. Note that description will be made later regarding a user interface that allows the user to create the user's own definition file. Now, description will be made below regarding a case in which a definition file has already been prepared.

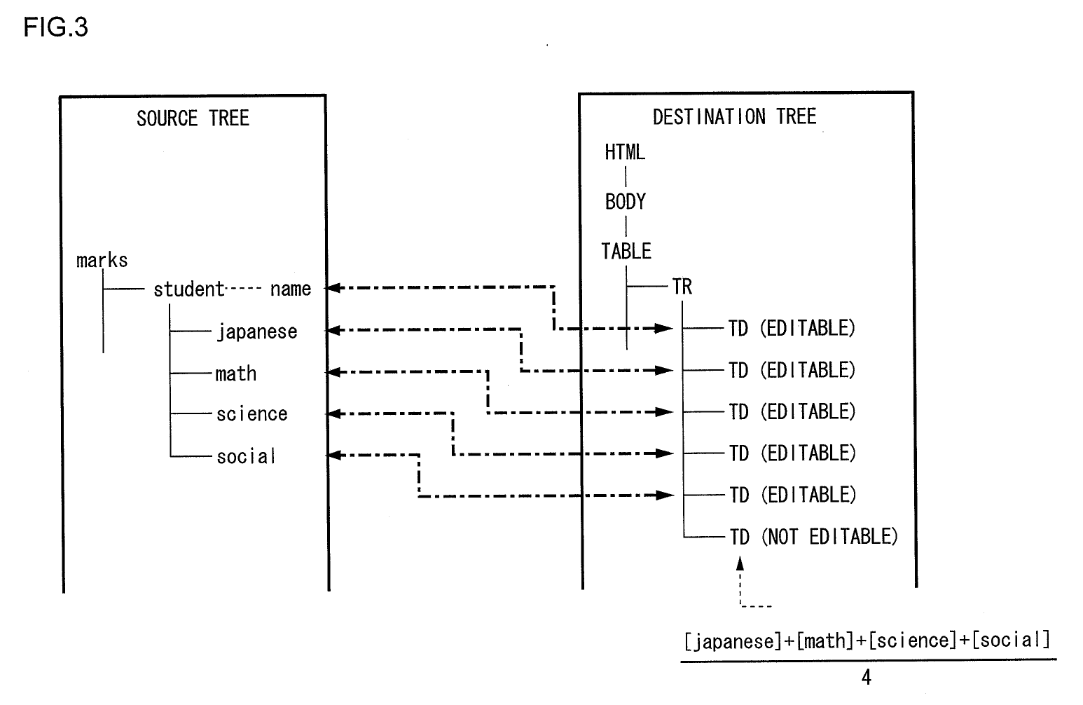

FIG. 3 shows an example in which the XML document shown in FIG. 2 is mapped to a table described in HTML. In an example shown in FIG. 3, a “student” Node in the marks managing vocabulary is associated with a row (“TR” Node) of a table (“TABLE” Node) in HTML. The first column in each row corresponds to an attribute value “name”, the second column to a “japanese” Node element value, the third column to a “mathematics” Node element value, the fourth column to a “science” Node element value and the fifth column to a “social_studies” Node element value. As a result, the XML document shown in FIG. 2 can be displayed in an HTML tabular format. Furthermore, these attribute values and element values are designated as being editable, so that the user can edit these values on a display screen using an editing function of HTML unit 50. In the sixth column, an operation expression is designated for calculating a weighted average of the marks for Japanese, mathematics, science and social studies, and average values of the marks for each student are displayed. In this manner, more flexible display can be effected by making it possible to specify the operation expression in the definition file, thus improving the users' convenience at the time of editing. In this example shown in FIG. 3, editing is designated as not being possible in the sixth column, so that the average value alone cannot be edited individually. Thus, in the mapping definition it is possible to specify editing or no editing so as to protect the users against the possibility of performing erroneous operations.

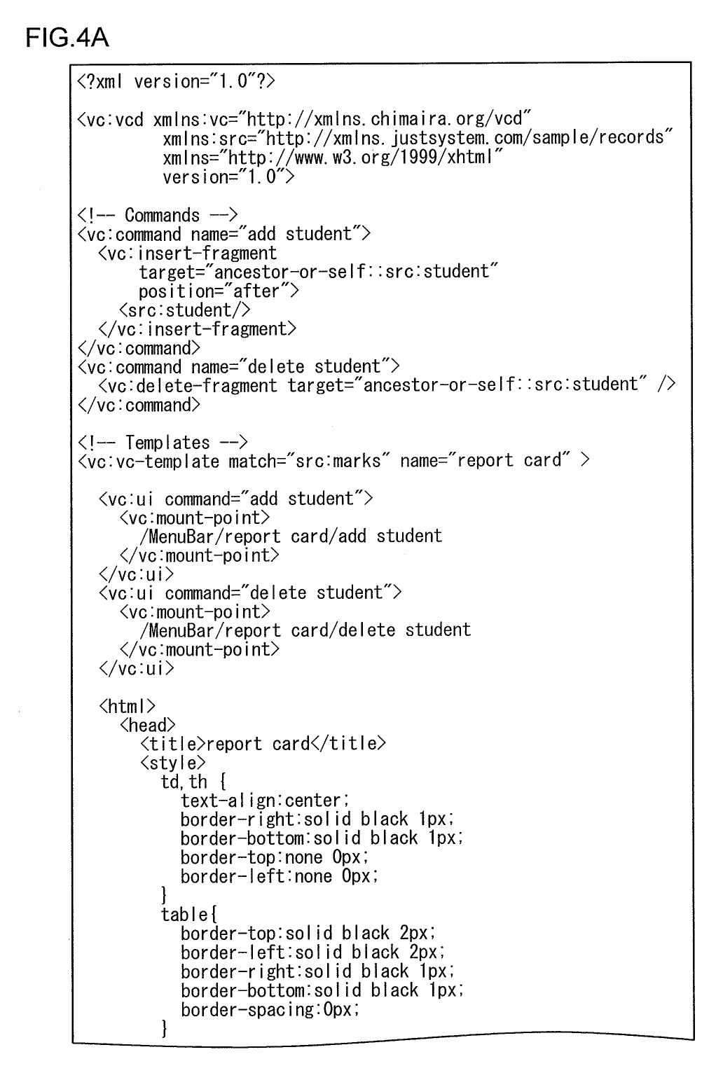

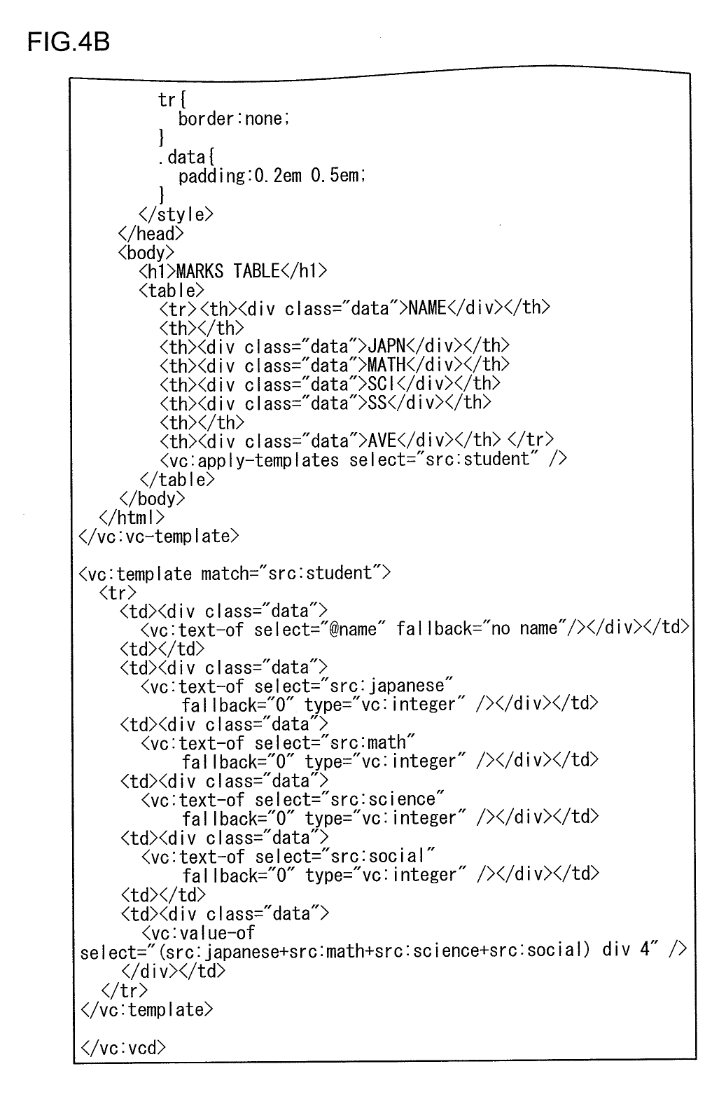

FIG. 4A and FIG. 4B illustrate an example of a definition file to map the XML document shown in FIG. 2 to the table shown in FIG. 3. This definition file is described in script language defined for use with definition files. In the definition file, definitions of commands and templates for display are described. In the example shown in FIG. 4A and FIG. 4B, “add student” and “delete student” are defined as commands, and an operation of inserting a Node “student” into a source tree and an operation of deleting the Node “student” from the source tree, respectively, are associated with these commands. Furthermore, the definition file is described in the form of a template, which describes that a header, such as “name” and “japanese”, is displayed in the first row of a table and the contents of the Node “student” are displayed in the second and subsequent rows. In the template displaying the contents of the Node “student”, a term containing “text-of” indicates that editing is permitted, whereas a term containing “value-of” indicates that editing is not permitted. Among the rows where the contents of the Node “student” are displayed, an operation expression “(src: japanese+src: mathematics+scr: science+scr: social_studies) div 4” is described in the sixth row. This means that the average of the student's marks is displayed.

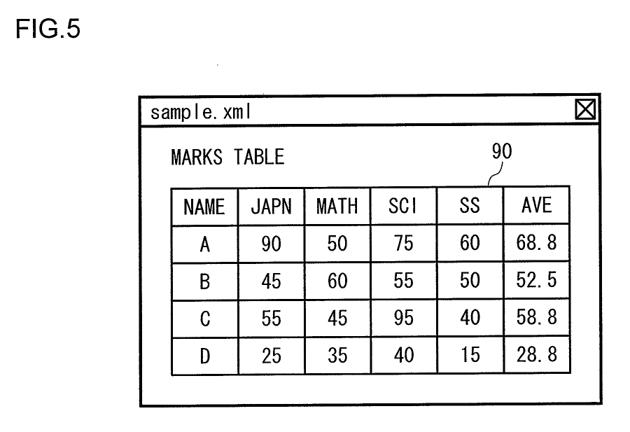

FIG. 5 shows an example of a display screen on which an XML document described in the marks managing vocabulary shown in FIG. 2 is displayed by mapping the XML document to HTML using the correspondence shown in FIG. 3. Displayed from left to right in each row of a table 90 are the names of each student, marks for Japanese, marks for mathematics, marks for science, marks for social studies and the averages thereof. The user can edit the XML document on this screen. For example, when the value in the second row and the third column is changed to “70”, the element value in the source tree corresponding to this Node, that is, the marks of student “B” for mathematics are changed to “70”. At this time, in order to have the destination tree follow the source tree, the VC unit 80 changes a relevant portion of the destination tree accordingly, so that HTML unit 50 updates the display based on the destination tree thus changed. Hence, the marks of student “B” for mathematics are changed to “70”, and the average is changed to “55” in the table on the screen.

On the screen as shown in FIG. 5, commands like “add student” and “delete student” are displayed in a menu as defined in the definition file shown in FIG. 4A and FIG. 4B. When the user selects a command from among these commands, a Node “student” is added or deleted in the source tree. In this manner, with the document processing apparatus 20 according to the Base Technology, it is possible not only to edit the element values of components in a lower end of a hierarchical structure but also to edit the hierarchical structure. An edit function for editing such a tree structure may be presented to the user in the form of commands. Furthermore, a command to add or delete rows of a table may, for example, be linked to an operation of adding or deleting the Node “student”. A command to embed other vocabularies therein may be presented to the user. This table may be used as an input template, so that marks data for new students can be added in a fill-in-the-blank format. As described above, the VC function allows a document described in the marks managing vocabulary to be edited using the display/editing function of HTML unit 50.

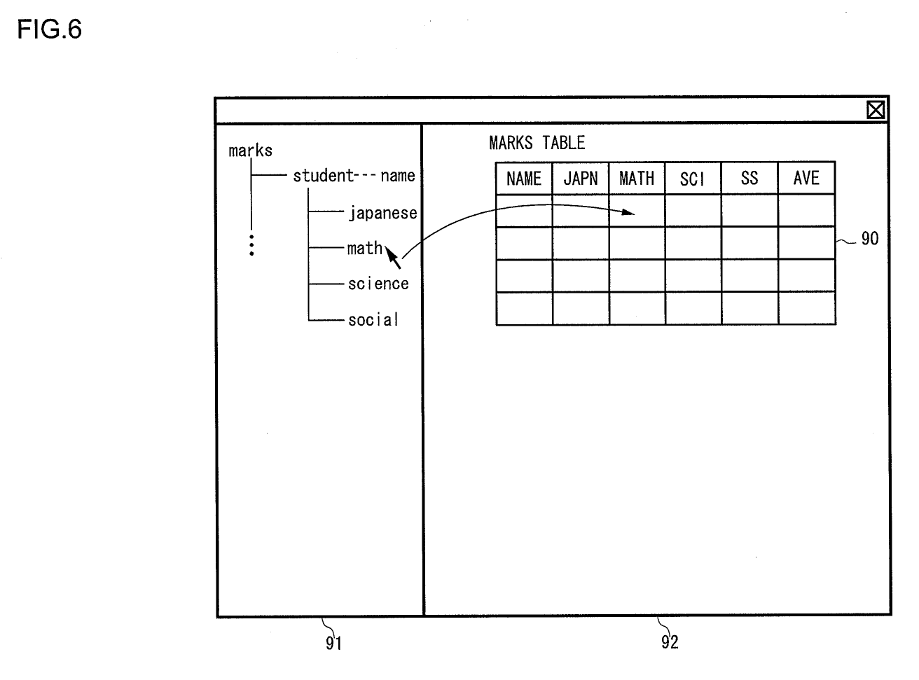

FIG. 6 shows an example of a graphical user interface, which the definition file generator 86 presents to the user, in command for the user to create a definition file. An XML document to be mapped is displayed in a tree in a left-hand area 91 of a screen. The screen layout of an XML document after mapping is displayed in a right-hand area 92 of the screen. This screen layout can be edited by HTML unit 50, and the user creates a screen layout for displaying documents in the right-hand area 92 of the screen. For example, a Node of the XML document which is to be mapped, which is displayed in the left-hand area 91 of the screen, is dragged and dropped into HTML screen layout in the right-hand area 92 of the screen using a pointing device such as a mouse, so that a connection between a Node at a mapping source and a Node at a mapping destination is specified. For example, when “mathematics,” which is a child element of the element “student,” is dropped to the intersection of the first row and the third column in a table 90 on HTML screen, a connection is established between the “mathematics” Node and a “TD” Node in the third column. Either editing or no editing can be specified for each Node. Moreover, the operation expression can be embedded in a display screen. When the screen editing is completed, the definition file generator 86 creates definition files, which describe connections between the screen layout and Nodes.

Viewers or editors which can handle major vocabularies such as XHTML, MathML and SVG have already been developed. However, it does not serve any practical purpose to develop dedicated viewers or editors for such documents described in the original vocabularies as shown in FIG. 2. If, however, the definition files for mapping to other vocabularies are created as mentioned above, the documents described in the original vocabularies can be displayed and/or edited utilizing the VC function without the need to develop a new viewer or editor.

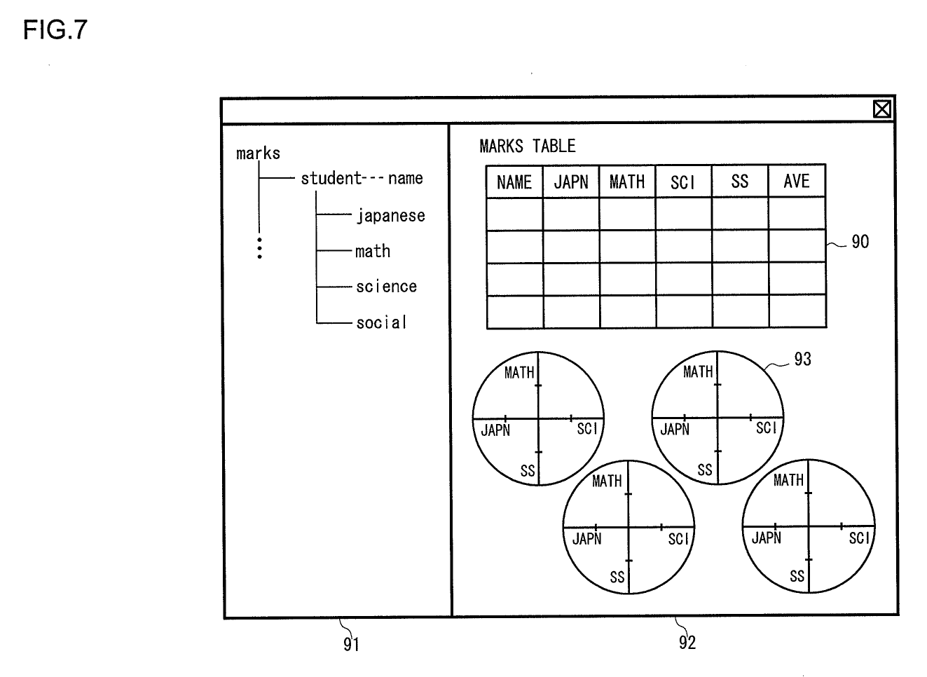

FIG. 7 shows another example of a screen layout created by the definition file generator 86. In the example shown in FIG. 7, a table 90 and circular graphs 93 are created on a screen for displaying XML documents described in the marks managing vocabulary. The circular graphs 93 are described in SVG. As will be discussed later, the document processing apparatus 20 according to the Base Technology can process a compound document described in the form of a single XML document according to a plurality of vocabularies. That is why the table 90 described in HTML and the circular graphs 93 described in SVG can be displayed on the same screen.

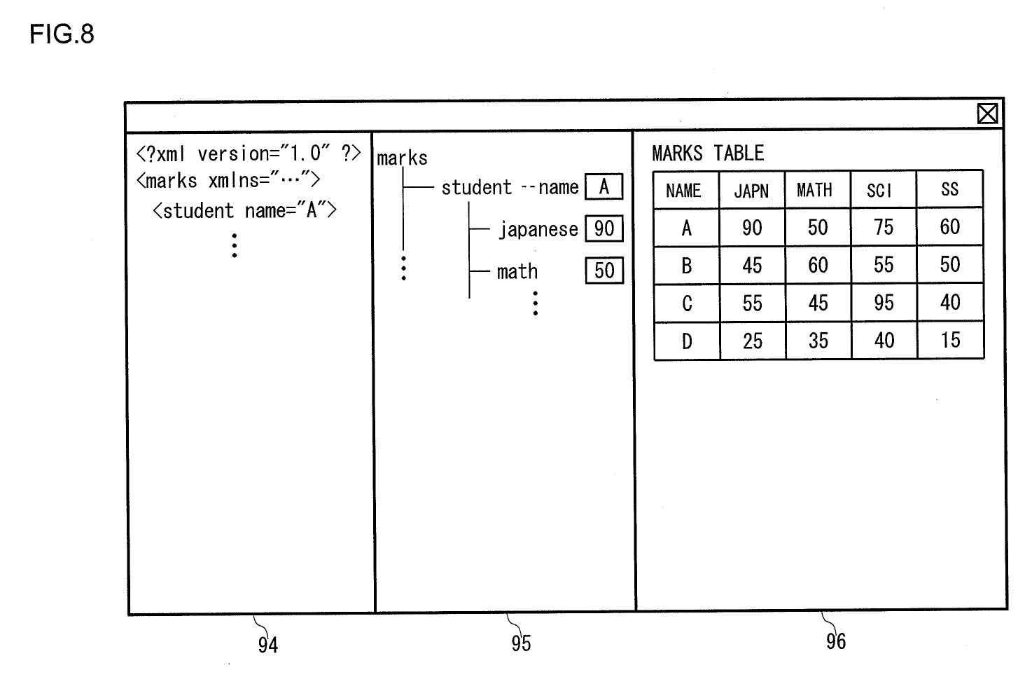

FIG. 8 shows an example of a display medium, which in a preferred but non-limiting embodiment is an edit screen, for XML documents processed by the document processing apparatus 20. In the example shown in FIG. 8, a single screen is partitioned into a plurality of areas and the XML document to be processed is displayed in a plurality of different display formats at the respective areas. The source of the document is displayed in an area 94, the tree structure of the document is displayed in an area 95, and the table shown in FIG. 5 and described in HTML is displayed in an area 96. The document can be edited in any of these areas, and when the user edits content in any of these areas, the source tree will be modified accordingly, and then each plug-in that handles the corresponding screen display updates the screen so as to effect the modification of the source tree. Specifically, display units of the plug-ins in charge of displaying the respective edit screens are registered in advance as listeners for mutation events that provide notice of a change in the source tree. When the source tree is modified by any of the plug-ins or the VC unit 80, all the display units, which are displaying the edit screen, receive the issued mutation event(s) and then update the screens. At this time, if the plug-in is executing the display through the VC function, the VC unit 80 modifies the destination tree following the modification of the source tree. Thereafter, the display unit of the plug-in modifies the screen by referring to the destination tree thus modified.

For example, when the source display and tree-view display are implemented by dedicated plug-ins, the source-display plug-in and the tree-display plug-in execute their respective displays by directly referring to the source tree without involving the destination tree. In this case, when the editing is done in any area of the screen, the source-display plug-in and the tree-display plug-in update the screen by referring to the modified source tree. Also, HTML unit 50 in charge of displaying the area 96 updates the screen by referring to the destination tree, which has been modified following the modification of the source tree.

The source display and the tree-view display can also be realized by utilizing the VC function. That is to say, an arrangement may be made in which the source and the tree structure are laid out in HTML, an XML document is mapped to HTML structure thus laid out, and HTML unit 50 displays the XML document thus mapped. In such an arrangement, three destination trees in the source format, the tree format and the table format are created. If the editing is carried out in any of the three areas on the screen, the VC unit 80 modifies the source tree and, thereafter, modifies the three destination trees in the source format, the tree format and the table format. Then, HTML unit 50 updates the three areas of the screen by referring to the three destination trees.

In this manner, a document is displayed on a single screen in a plurality of display formats, thus improving a user's convenience. For example, the user can display and edit a document in a visually easy-to-understand format using the table 90 or the like while understanding the hierarchical structure of the document by the source display or the tree display. In the above example, a single screen is partitioned into a plurality of display formats, and they are displayed simultaneously. Also, a single display format may be displayed on a single screen so that the display format can be switched according to the user's instructions. In this case, the main control unit 22 receives from the user a request for switching the display format and then instructs the respective plug-ins to switch the display.

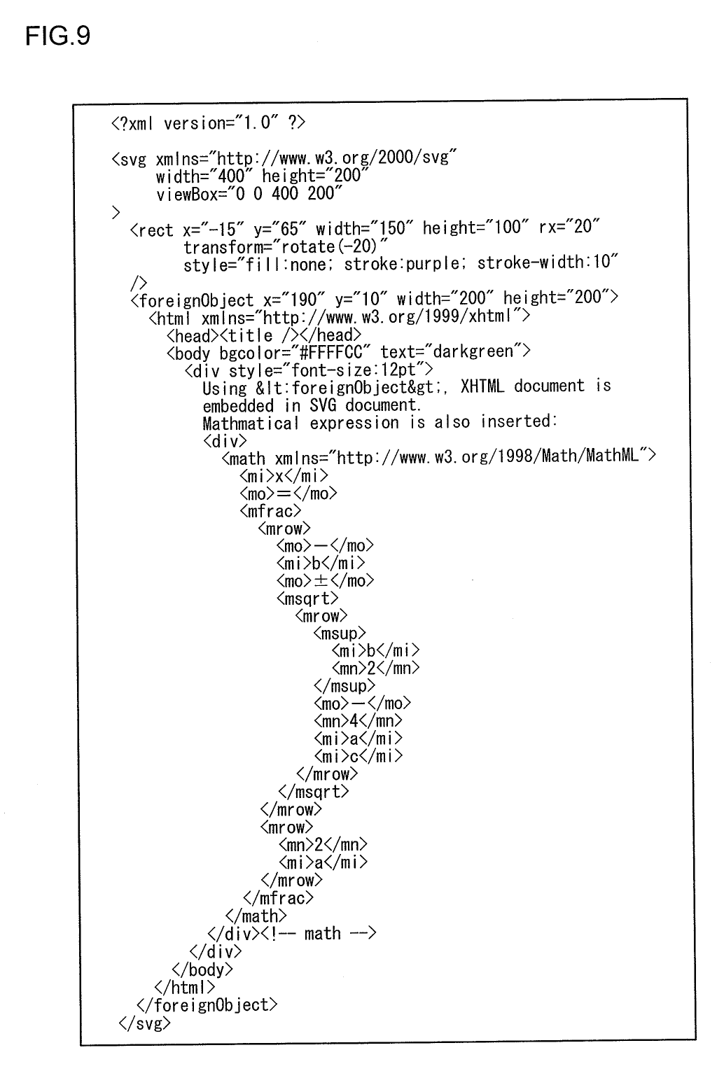

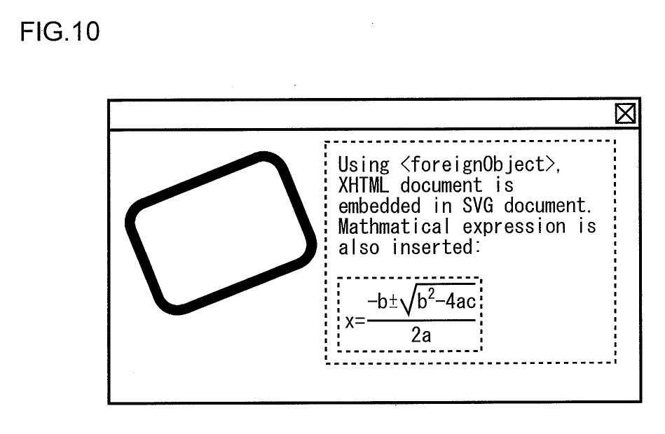

FIG. 9 illustrates another example of an XML document edited by the document processing apparatus 20. In the XML document shown in FIG. 9, an XHTML document is embedded in a “foreignObject” tag of an SVG document, and the XHTML document contains an equation described in MathML. In this case, the editing unit 24 assigns the rendering job to an appropriate display system by referring to the name space. In the example illustrated in FIG. 9, first, the editing unit 24 instructs the SVG unit 60 to render a rectangle, and then instructs HTML unit 50 to render the XHTML document. Furthermore, the editing unit 24 instructs a MathML unit (not shown) to render an equation. In this manner, the compound document containing a plurality of vocabularies is appropriately displayed. FIG. 10 illustrates the resulting display.

The displayed menu may be switched corresponding to the position of the cursor (carriage) during the editing of a document. That is, when the cursor lies in an area where an SVG document is displayed, the menu provided by the SVG unit 60, or a command set which is defined in the definition file for mapping the SVG document, is displayed. On the other hand, when the cursor lies in an area where the XHTML document is displayed, the menu provided by HTML unit 50, or a command set which is defined in the definition file for mapping HTML document, is displayed. Thus, an appropriate user interface can be presented according to the editing position.

In a case that there is neither a plug-in nor a mapping definition file suitable for any one of the vocabularies according to which the compound document has been described, a portion described in this vocabulary may be displayed in source or in tree format. In the conventional practice, when a compound document is to be opened where another document is embedded in a particular document, their contents cannot be displayed without the installation of an application to display the embedded document. According to the Base Technology, however, the XML documents, which are composed of text data, may be displayed in source or in tree format so that the contents of the documents can be ascertained. This is a characteristic of the text-based XML documents or the like.

Another advantageous aspect of the data being described in a text-based language, for example, is that, in a single compound document, a part of the compound document described in a given vocabulary can be used as reference data for another part of the same compound document described in a different vocabulary. Furthermore, when a search is made within the document, a string of characters embedded in a drawing, such as SVG, may also be search candidates.

In a document described in a particular vocabulary, tags belonging to other vocabularies may be used. Though such an XML document is generally not valid, it can be processed as a valid XML document as long as it is well-formed. In such a case, the tags thus inserted that belong to other vocabularies may be mapped using a definition file. For instance, tags such as “Important” and “Most Important” may be used so as to display a portion surrounding these tags in an emphasized manner, or may be sorted out in the command of importance.

When the user edits a document on an edit screen as shown in FIG. 10, a plug-in or a VC unit 80, which is in charge of processing the edited portion, modifies the source tree. A listener for mutation events can be registered for each Node in the source tree. Normally, a display unit of the plug-in or the VC unit 80 conforming to a vocabulary that belongs to each Node is registered as the listener. When the source tree is modified, the DOM provider 32 traces toward a higher hierarchy from the modified Node. If there is a registered listener, the DOM provider 32 issues a mutation event to the listener. For example, referring to the document shown in FIG. 9, if a Node which lies lower than the <html> Node is modified, the mutation event is notified to HTML unit 50, which is registered as a listener to the <html> Node. At the same time, the mutation event is also notified to the SVG unit 60, which is registered as a listener in an <svg> Node, which lies upper to the <html> Node. At this time, HTML unit 50 updates the display by referring to the modified source tree. Since the Nodes belonging to the vocabulary of the SVG unit 60 itself are not modified, the SVG unit 60 may disregard the mutation event.

Depending on the contents of the editing, modification of the display by HTML unit 50 may change the overall layout. In such a case, the layout is updated by a screen layout management mechanism, e.g., the plug-in that handles the display of the highest Node, in increments of display regions which are displayed according to the respective plug-ins. For example, in a case of expanding a display region managed by HTML unit 50, first, HTML unit 50 renders a part managed by HTML unit 50 itself, and determines the size of the display region. Then, the size of the display area is notified to the component that manages the screen layout so as to request the updating of the layout. Upon receipt of this notice, the component that manages the screen layout rebuilds the layout of the display area for each plug-in. Accordingly, the display of the edited portion is appropriately updated and the overall screen layout is updated.

### Embodiment

The embodiment is directed to allowing users to integrate web services provided in the form of XML data in a single web page and display the resultant page. For this purpose, there is proposed a technology of converting XML data into HTML data and providing the resultant data, by using the document processing apparatus 20 of the base technology. In this process, Ajax is used in order to allow users to access XML data in an interactive manner.

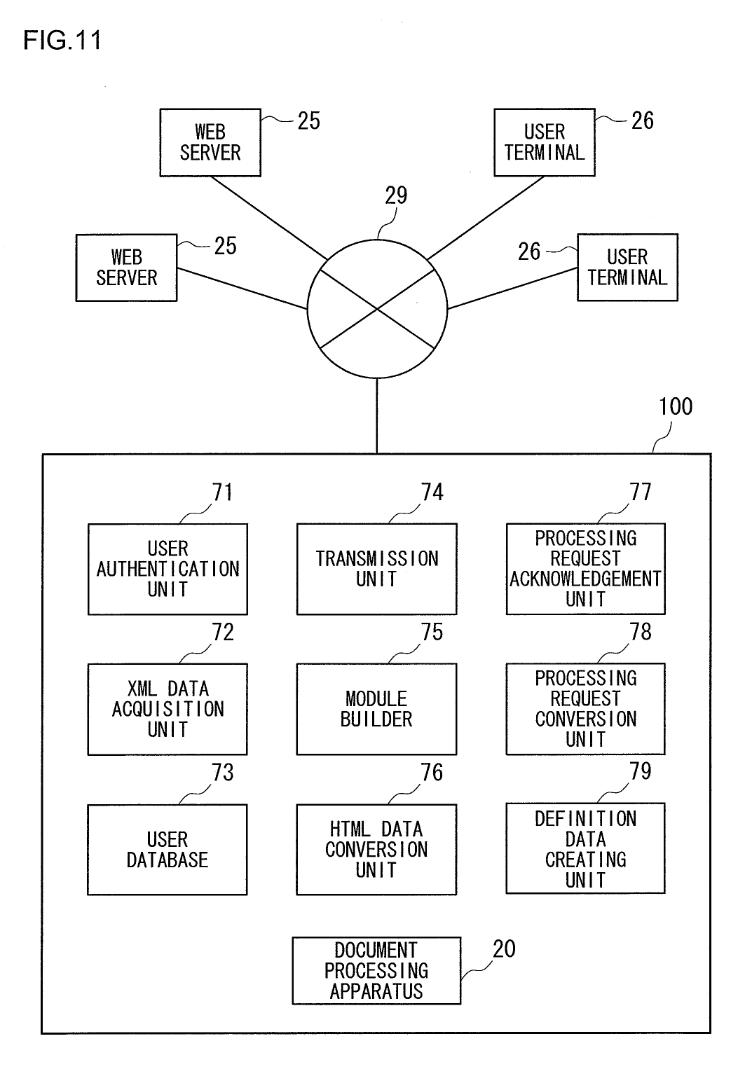

FIG. 11 shows the structure of a data processing server 100 according to the embodiment. In addition to the components of the document processing apparatus 20 described in relation to the base technology, the data processing server 100 is provided with a user authentication unit 71, an XML data acquisition unit 72, a user database 73, a transmission unit 74, a module builder 75, an HTML data conversion unit 76, a processing request acknowledgement unit 77, a processing request conversion unit 78. In the example shown in FIG. 11, the data processing server 100 functions as a middle layer server for converting XML data of a web service provided by a web server 25 via the Internet 29 into HTML data viewable by a user terminal and providing the resultant data.

The user authentication unit 71 authenticates the user of a user terminal 26. The user authentication unit 71 acknowledges a request for registration from the user requesting service from the data processing server 100 according to the embodiment and registers information such as a user ID and a password for authenticating the user in the user database 73. Upon acknowledging a request for service from the user terminal 26, the unit 71 acknowledges a user ID, a password, etc. from the user and verifies whether the requesting user is registered in the user database 73. The user authentication unit 71 acknowledges a request from the user for registration of XML data constituting the content to be displayed on a web page and registers the XML data acknowledged or the address of XML data acknowledged, etc. in the user database 73.

The XML data acquisition unit 72 is configured to acquire XML data provided by the web server 25. The XML data acquisition unit 72 refers to the user database 73 so as to acquire the address of XML data registered by the authenticated user and request the web server 25 to provide the XML data, based on the address. The XML data acquired is transmitted to the document processing apparatus 20. The document processing apparatus 20 uses the DOM builder 34 to build a source DOM and manages the XML data as a DOM.

The HTML data conversion unit 76 converts the XML data acquired by the XML data acquisition unit 72 into HTML data. The HTML data conversion unit 76 maintains a definition file for XSLT or a definition file of the base technology for each tag set (vocabulary) of XML data. The unit 76 converts the XML data acquired into HTML data in accordance with the definition file.

The module builder 75 builds a module for acknowledging a request for processing XML data as a request for processing HTML data. The module may be described in Java (registered trademark) Script. An event handler described in Java (registered trademark) Script may detect an action by the user and request a process on XML data through asynchronous communication using XMLHttpRequest, which is a built-in class of Java (registered trademark) Script. The module builder 75 may maintain, for respective XML data provided by the web server 25, modules prepared for processing the XML data. Alternatively, the builder 75 may maintain, for tag sets, modules prepared for processing XML data described in the respective tag sets. The module builder 75 may maintain prepared modules used for general purposes. For example, the builder 75 may maintain a button for requesting addition of new content to a web page, or a button for requesting download of an implementation described later.

The transmission unit 74 attaches the module built by the module builder 75 to the HTML data produced by conversion by the HTML data conversion unit 76 so as to create an HTML file describing a web page. The transmission unit 74 transmits the file thus created.

The user terminal 26 displays the received HTML file in a web browser, thereby presenting the web page to the user. The user is capable of using the module attached to the HTML file to issue a request for the data processing server 100 to process the data. The browser of the user terminal 26 has, for example, a built-in Ajax engine and is adapted to detect an action by the user as an event and issue a processing request as described to the data processing server 100 asynchronously.

The processing request acknowledgement unit 77 acknowledges a processing request issued by the user terminal 26. The processing request conversion unit 78 converts the processing request acknowledged into an instruction that the document processing apparatus 20 is capable of interpreting and executing. The unit 76 communicates the instruction to the document processing apparatus 20. The document processing apparatus 20 executes a necessary process such as changing a source DOM, in accordance with the instruction communicated.

If it is required that a source DOM be changed and the display of a web page be updated, the HTML conversion unit 76 converts the modified XML data into HTML data. The transmission unit 74 transmits the HTML data produced by conversion to the user terminal 26. Since XMLHttpRequest is capable of communicating XML data, the XML data may be transmitted to the user terminal 26 without conversion if the user terminal 26 is capable of handling XML data.

Upon receipt from the user terminal 26 a request for locally editing a web page containing XML data as content, a definition data creating unit 79 generates definition data for editing the web page in the document processing apparatus 20. As described in relation to the base technology, the definition data creating unit 79 generates definition data describing a rule for mapping XML data into a tag set that can be processed by an implementation included in the document processing apparatus 20 and adapted to process XML data described in a specific tag set (e.g., the HTML unit 50 or the SVG unit 60). The definition data generated is transmitted by the transmission unit 74 to the user terminal 26. If the functional modules of the document processing apparatus 20 are not installed in the user terminal 26, the transmission unit 74 transmits a program for implementing the document processing apparatus 20 to the user terminal 26.

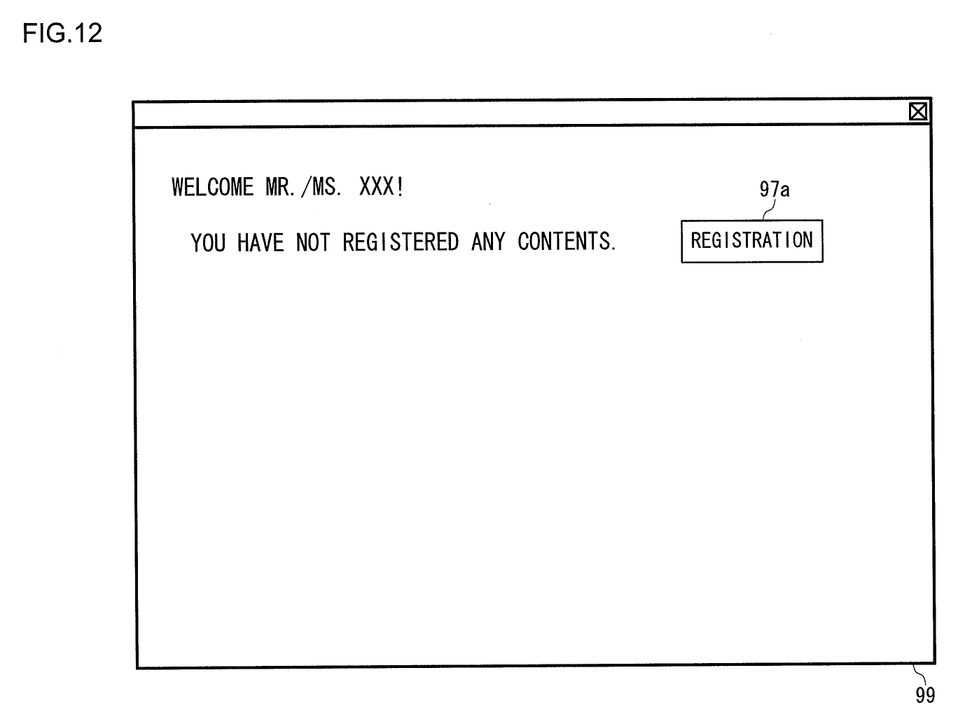

FIG. 12 shows an exemplary screen 99 displayed in a browser of the user terminal 26 of the user authenticated by the user authentication unit 71. This user has not registered any web page content yet and proceeds to register content by clicking on a registration button 97a. Upon acknowledging a request for registering content, the user authentication unit 71 registers the address of XML data of the content in the user database 73.

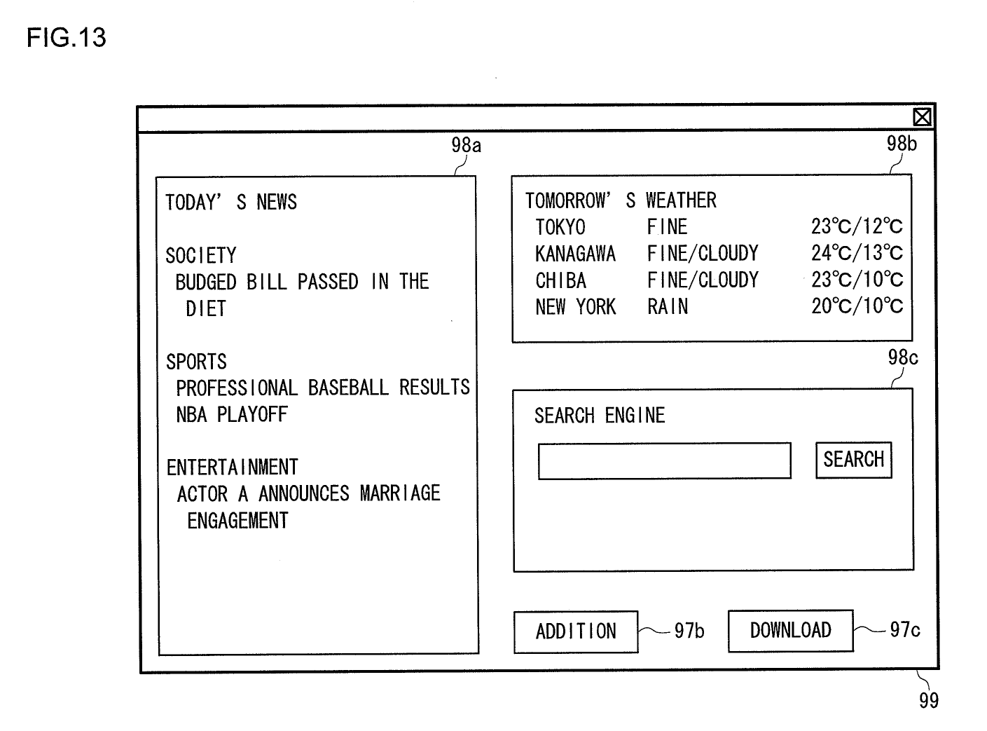

FIG. 13 shows an exemplary screen 99 showing a web page containing a plurality of contents. An RSS 98a of a news site, an RSS 98b of a weather forecast site, and an interface 98c of a search engine are registered as content in this web page. The XML data acquisition unit 72 refers to the user database 73, acquires the data for these contents from the web server 25, and transmits the acquired data to the document processing apparatus 20. The document processing apparatus 20 manages the acquired XML data as a DOM. In order to allow the web page to be viewed in an ordinary web browser of the user terminal 26, the HTML data conversion unit 76 converts the XML data into HTML data. Further, in order to allow the user to work on and edit the XML data, the module builder 75 builds a module for acknowledging a request for processing the XML data. The transmission unit 74 attaches the module built to the HTML data produced by conversion so as to create a web page. The unit 74 transmits the web page created to the user terminal 26. The user terminal 26 displays the received web page on the screen 99.

The module attached to the web page provides the screen 99 with, for example, an addition button 97b for adding content and a download button 97c for downloading an editing environment. A request for editing content such as the RSS 98a of a news site is acknowledged.

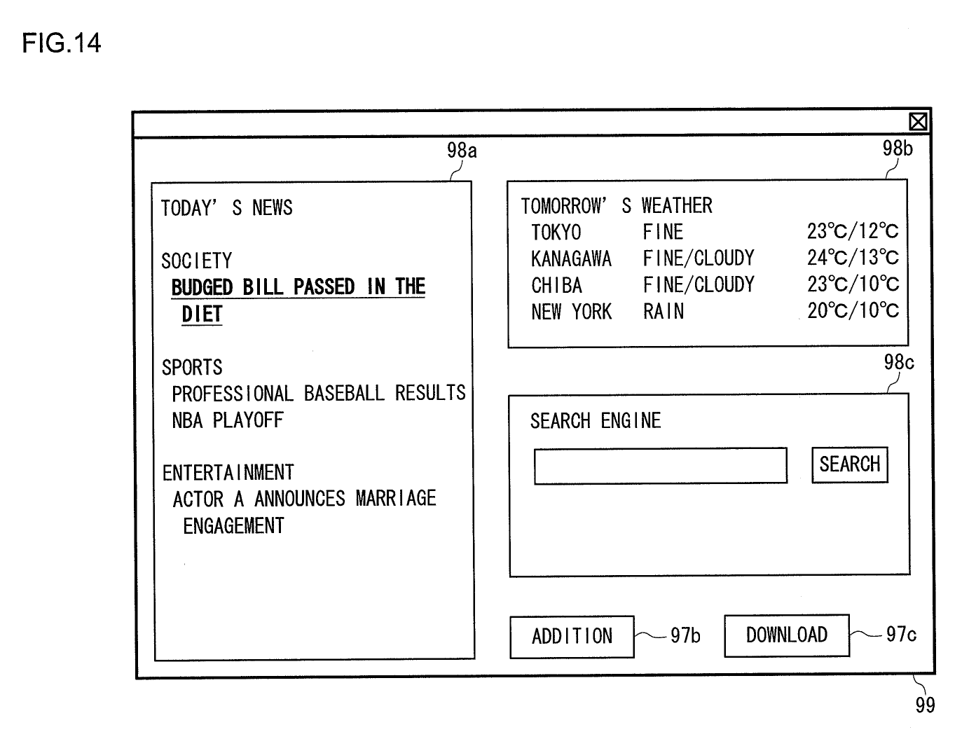

FIG. 14 shows an exemplary screen 99 in which the web page is edited. The module for processing the RSS 98a of a news site does not only modify a character string of a title of an article but also accepts annotation. For example, when the user selects a character string “Budget bill passed in the Diet” and requests annotating the character string, the module for editing the RSS 98a transmits a processing request to the data processing server 100. When the processing request acknowledgement unit 77 of the data processing server 100 acknowledges the processing request, the processing request conversion unit 78 converts the request into an instruction for attaching an annotation tag to the relevant character string and communicates the instruction to the document processing apparatus 20. The document processing apparatus 20 adds a new annotation element and configures the relevant character string as an element value of the element. The HTML data conversion unit 76 converts the newly added element into <B><U> tags of HTML. The transmission unit 74 does not re-transmit the whole web page but transmits only the modified HTML data to the user terminal 26. The user terminal 26 uses the received HTML data to re-display the edited portion. In this way, the character string “Budget bill passed in the Diet” is highlighted by bold letters and an underline.

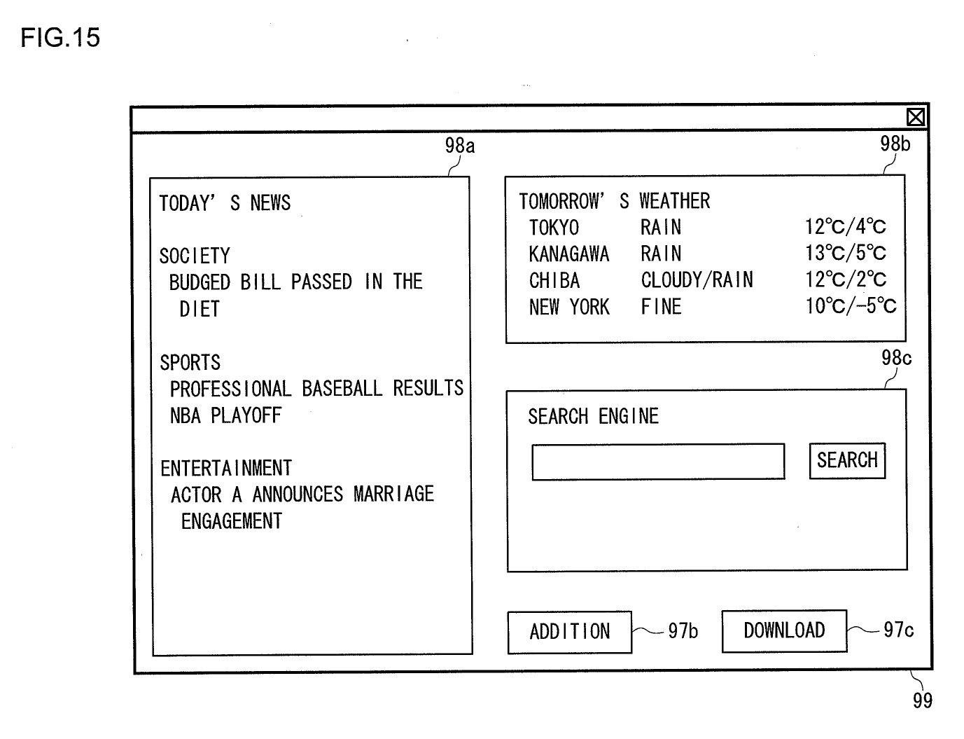

FIG. 15 shows an exemplary screen 99 in which a portion of a web page is updated. In order to reflect updates to RSS provided by the web server 25 on the screen, the module for processing the RSS 98b of a weather forecast site transmits a processing request to the data processing server 100 periodically to inquire about updates. When the processing request acknowledgement unit 77 of the data processing server 100 acknowledges the processing request, the processing request conversion unit 78 directs the document processing apparatus 20 to re-read the RSS from the weather forecast site. The document processing apparatus 20 uses the XML data acquisition unit 72 to re-read the RSS of the news site from the web server 25. If the RSS is modified, the source DOM is updated. The HTML data conversion unit 76 converts the modified XML data into HTML data. The transmission unit 74 transmits the modified HTML data to the user terminal 26. The user terminal 26 uses the received HTML data to re-display the updated portion. In this way, the RSS 98b of the weather forecast site is automatically updated.

As described in relation to the base technology, the document processing apparatus 20 manages XML data described in any tag set as a DOM in an integrated fashion. Accordingly, even if a plurality of web sites are integrated in a web page and a plurality of tag sets are included, XML data can be processed properly.

Given above is a description based on an embodiment. The embodiment is intended to be illustrative only and it will be obvious to those skilled in the art that various modifications to constituting elements and processes could be developed and that such modifications are also within the scope of the present invention.

### INDUSTRIAL APPLICABILITY

The present invention is applicable to a data processing server adapted to convert XML data into HTML data and provide the resultant data.

1. A data processing server comprising:
an XML data acquisition unit operative to acquire XML data;
an HTML data conversion unit operative to convert XML data into HTML data;
a transmission unit operative to attach, to the HTML data produced by conversion, a module for acknowledging a request for processing the XML data as a request for processing HTML data and to transmit the resultant data; and
a processing unit operative to acknowledge a request, provided via the module, for processing the XML data and to process the XML data accordingly.

2. The data processing server according to claim 1 further comprising a processing request conversion unit operative to convert a request, provided via the module, for processing the XML data into an instruction that can be executed by the processing unit.

3. The data processing server according to claim 1, wherein
upon being requested to process the XML data via the module, the HTML data conversion unit converts the XML data processed by the processing unit into HTML data, and
the transmission unit transmits the HTML data produced by conversion to the destination requesting the XML data to be processed.

4. The data processing server according to claim 1, wherein
the HTML data conversion unit maintains, for each tag set of XML, a rule for converting XML data into HTML data, and converts the XML data acquired by the XML data acquisition unit into HTML data in accordance with the rule.

5. The data processing server according to claim 1, further comprising a module builder operative to build a module in accordance with the XML data.

6. The data processing server according to claim 5, wherein
the HTML data is data describing a web page displayed in a web browser of a user terminal,
the module acknowledges a request for adding XML data to be displayed as content in the web page,
the XML data acquisition unit acquires the XML data requested to be added,
the HTML data conversion unit converts the XML data additionally acquired into HTML data,
the module builder builds a module for acknowledging a request for processing the XML data additionally acquired, and
the transmission unit attaches the HTML data produced by conversion to the original HTML data, attaches the module built to the resultant HTML data, and transmits the resultant data to the user terminal.

7. The data processing server according to claim 6, further comprising a user database operative to store XML data to be displayed in the web page or an address of the XML data.

8. The data processing server according to claim 6, wherein
upon receipt from the user terminal a request for locally editing the XML data, the transmission unit transmits the processing unit to the user terminal.

9. The data processing server according to claim 8, wherein the processing unit further comprises:
a tag set processing unit operative to process data described in a specific tag set of XML; and
a mapping unit operative to map the XML data into a tag set that can be processed by the tag set processing unit and maintain correspondence between the elements mapped,
the data processing server further comprising a definition data creating unit operative to generate definition data describing a rule for mapping the XML data included in a web page to be transmitted to the user terminal into a tag set that can be processed by the tag set processing unit, wherein
the transmission unit transmits the definition data to the user terminal along with the processing unit.

10. A data processing method comprising:
acquiring XML data;
converting XML data into HTML data;
attaching, to the HTML data produced by conversion, a module for acknowledging a request for processing the XML data as a request for processing HTML data, and transmitting the resultant data; and
acknowledging a request, provided via the module, for processing the XML data and processing the XML data accordingly.

11. A computer program product comprising:
a module operative to acquire XML data;
a module operative to convert XML data into HTML data;
a module operative to attach, to the HTML data produced by conversion, a module for acknowledging a request for processing the XML data as a request for processing HTML data, and to transmit the resultant data; and
a module operative to acknowledge a request, provided via the module, for processing the XML data and to process the XML data accordingly.
